(19) United States
(12) Patent Application Publication
(10) Pub. No.: US 2012/0150924 A1
(43) Pub. Date: Jun. 14, 2012

(54) APPARATUS FOR SUPPORTING CONTINUOUS READ/WRITE IN ASYMMETRIC STORAGE SYSTEM AND METHOD THEREOF

(75) Inventors: Sang Min LEE, Daejeon (KR); Hee Sun WON, Daejeon (KR); Sung Jin HUR, Daejeon (KR)

(73) Assignee: Electronics and Telecommunications Research Institute, Daejeon (KR)

(21) Appl. No.: 13/314,693

(22) Filed: Dec. 8, 2011

(30) Foreign Application Priority Data
Dec. 9, 2010 (KR) 10-2010-0125860

(51) Int. Cl. G06F 7/00

(52) U.S. Cl. 707/821; 707/E17.01

(57) ABSTRACT

Disclosed are an apparatus for supporting continuous read/write in an asymmetric storage system, and a method thereof are provided. The apparatus for supporting continuous read/write in an asymmetric storage system that permits continuous reading/writing by providing context identifiers for reading or writing files and requesting reading or writing the files, using the context identifiers. Therefore, it is possible to efficiently process continuous reading or writing, improve performance of data service, and reduce waster of a memory by removing context identifies for reading or writing files when the files are not used any more or not frequently used.

### CROSS-REFERENCE TO RELATED APPLICATIONS

This application claims priority to and the benefit of Korean Patent Application No. 10-2010-0125860 filed in the Korean Intellectual Property Office on Dec. 9, 2010, the entire contents of which are incorporated herein by reference.

### TECHNICAL FIELD

The present invention relates to an asymmetric storage system, and more particularly, to an apparatus for supporting continuous read/write in an asymmetric storage system that permits continuous reading/writing by providing context identifiers for reading or writing files and requesting reading or writing the files, using the context identifiers, and a method thereof.

### BACKGROUND

In general, most large-capacity storage systems have adopted an asymmetric structure that separately processes metadata with a metadata server and data with a data server, for high expandability. The data server stores and manages data in order for a user to process the data.

It is possible to achieve high performance while reducing disc input/output (I/O) by processing a bundle of requests for reading or requests for writing at one time, rather than individually requesting continuous reading or writing to a disc, which is a typical storage medium for a data server.

The type of continuous reading and writing is used in most local file systems.

FIG. 1 is an exemplary diagram showing the configuration of a common asymmetric storage system according to the related art.

As shown in FIG. 1, the asymmetric storage system according to the related art includes n local file systems 110, a metadata server 120, and n data servers 130.

The local file systems 110 receive requests relating to user's files and request metadata to the metadata sever and file data to the data servers.

When receiving a request from a local file system, the metadata servers 120, which manage positional information on the file data, examine validity of the request from the local file system and send requested metadata, that is, the positional information on the file data through a network.

The data server 130 manages file data and transmits file data of a disc in accordance with a request from a local file system.

FIG. 2 is an exemplary diagram illustrating pre-reading of a local file system according to the related art.

As shown in FIG. 2, when a user opens a file, the local file system generates a file object including the pre-reading size. If the user continuously requests reading, the local file system reads out data at once in advance by gradually increasing the size of pre-reading of the file object.

The pre-reading of the local file system is performed by opening and continuously reading a file. However, if it is not continuous, the size of pre-reading is reset and pre-reading is not performed.

Further, when the file is closed, the file object is removed, such that pre-reading is not performed when pre-reading is executed again.

FIG. 3 is an exemplary diagram illustrating a writing process of a local file system according to the related art.

As shown in FIG. 3, when a user opens a file, the local file system generates a file object including a space for buffering. If a user requests continuous writing, a local file system does not directly write the requests on a disc, but collects the requests on a space for buffering on a memory and writes them onto a disc at one time, such that seek time of the disc is reduced.

As described above, the data sever of an asymmetric storage system has individually processed requests for data service from a user connected though a network. According to such a processing method, since a data server individually processes reading and writing requests, even for continuous reading and writing service processes, a lot of data is input and output, such that the performance of data service decreases.

### SUMMARY

The present invention has been made in an effort to provide an apparatus for supporting continuous read/write in an asymmetric storage system that permits continuous reading/writing by providing context identifiers for reading or writing files and requesting reading or writing the files, using the context identifiers, and a method thereof.

An exemplary embodiment of the present invention provides an apparatus for supporting continuous read/write, including: a data service processing unit that controls generating and deleting of a context structure, which is assigned for a reading or writing process for each user, and reading and writing of file data, in accordance with a data service request from the users; and a data context managing unit that generates the context structure in accordance with a context generation request and provides a context identifier and a context generation number included in the generated context structure to the data service processing unit, in which the context managing unit determines that the request is continuous reading or continuous writing when the position where a local file system requests reading or writing agrees with the next reading position or the next writing position of the context structure, through the context identifier and the context generation number, and then performs a continuous reading request or a continuous writing request, using a file descriptor of the context structure.

The context managing unit may determines that a request is continuous reading, when the context generation number of the reading request and the context generation number of the context structure list head agree with each other, the context identifier of the reading request and the context identifier of the context structure agree with each other, and the reading request position and the next reading position of the context structure agree with each other.

The context managing unit may determines that a request is continuous writing, when the context generation number of the writing request and the context generation number of the context structure list head agree with each other, the context identifier of the writing request and the context identifier of the context structure agree with each other, and the writing request position and the next writing position of the context structure agree with each other.

If necessary, the context structure may includes at least one of a context identifier field that represents information given to each of users who requests reading or writing, a common information field that represents information that is used in reading or writing, a reading information field that represents information that is used in a continuous reading process, and a writing information field that represents information that is used in a continuous writing process.

The read information field may includes a next reading position field that represents the next reading position value for determining whether the reading request is continuous reading.

The write information field may includes a next writing position field that represents the next writing position value for determining whether the writing request is continuous writing.

If necessary, the data service processing unit may performs a process of generating or deleting a data file.

The context managing unit may manage a context structure list including a plurality of context structure, using a context structure list head.

If necessary, the context structure list head may includes a PREV field that represents an indicator for connecting the previous context structure, a NEXT field that represents an indicator for connecting the next context structure, a list lock filed that controls a list configuration, an identifier generation lock field that increases the value of a context identifier to generate, a latest identifier field that represents the value of the latest issued context identifier, a context generation number that represents a number corresponding to the context identifier value, and a timeout field that represents a time where a context structure can be maintained as long as possible.

The context managing unit may generates the context identifier in accordance with the context generation request of a local file system and generate the context generation number corresponding to the context identifier, and the context generation number is generated by increasing one by one the context generation numbers stored in the local file system.

Another exemplary embodiment of the present invention provides an asymmetric storage system, including: a local file system that requests for generating a context structure for reading or writing in accordance with a data service request from a user; and a data server that generates a context structure in accordance with a context generation request and provides a context identifier and a context generation number included in the context structure to the local file system, in which the data server determines that the request is continuous reading, when the reading request position of the local file system agrees with the next reading position of the context structure, through the context identifier and the context generation number, and then performs a continuous reading request, using a file descriptor of the context structure.

Yet another exemplary embodiment of the present invention provides a method for supporting continuous read/write, including: generating a context structure including a context identifier that is assigned for each of users who requests reading, when receiving the reading requests from the users; determining whether the reading request position agrees with the next reading position of the context structure; and determining that the request is continuous reading, when the reading request position of the local file system agrees with the next reading position of the context structure, as the result of determining, and then performing a continuous reading request, using a file descriptor of the context structure.

The generating a context structure may includes: generating a context structure list head for managing a list including a plurality of context structure in accordance with a context generation request from a local file system receiving a reading request from a user; generating a context generation number included in the context structure list head; generating the context structure assigned to each of users who requests reading; generating the context identifier included in the context structure; and providing the context generation number and the context identifier to the local file system that requests reading.

The determining whether the reading request position agrees with the next reading position may includes: determining whether the context generation number of the reading request and the context generation number of the context structure list head agree with each other in accordance with a reading request from a local file system through the context generation number and the context identifier; determining whether the context identifier of the reading request and the context identifier of the context structure agree with each other when the context generation numbers agree with each other; and determining whether the position of the reading request agrees with the next reading position of the context structure when the context identifiers agree with each other.

The method for supporting continuous read/write may further includes updating the next reading position of the context structure to a value obtained by adding the position value of the reading request and the size value of the reading request, after performing the continuous reading request.

Still another exemplary embodiment of the present invention provides a method for supporting continuous read/write, including: generating a context structure including a context identifier that is assigned for each of users who request writing, when receiving the writing requests from the users; determining whether the writing request position agrees with the next writing position of the context structure; and determining that the request is continuous writing, when the writing request position of the local file system agrees with the next writing position of the context structure, as the result of determining, and then performing a continuous writing request, using a file descriptor of the context structure.

The method for supporting continuous read/write may further includes: updating the next writing position of the context structure to a value obtained by adding the position value of the writing request and the size value of the writing request, after performing the continuous writing request; and updating the buffer writing position of the context structure to a value obtained by adding the buffer writing position value of the writing request and the size value of the writing request.

According to the exemplary embodiments of the present invention, it is possible to efficiently process continuous reading or writing by providing context identifiers for reading or writing files and requesting reading or writing the files, using the context identifiers.

Further, according to the exemplary embodiments of the present invention, it is possible to improve performance of data service by providing context identifiers for reading or writing files and requesting reading or writing the files, using the context identifiers.

In addition, according to the exemplary embodiments of the present invention, it is possible to reduce waster of a memory by removing context identifies for reading or writing files when the files are not used any more or not frequently used.

### BRIEF DESCRIPTION OF THE DRAWINGS

FIG. 1 is an exemplary diagram showing the configuration of a common asymmetric storage system according to the related art.

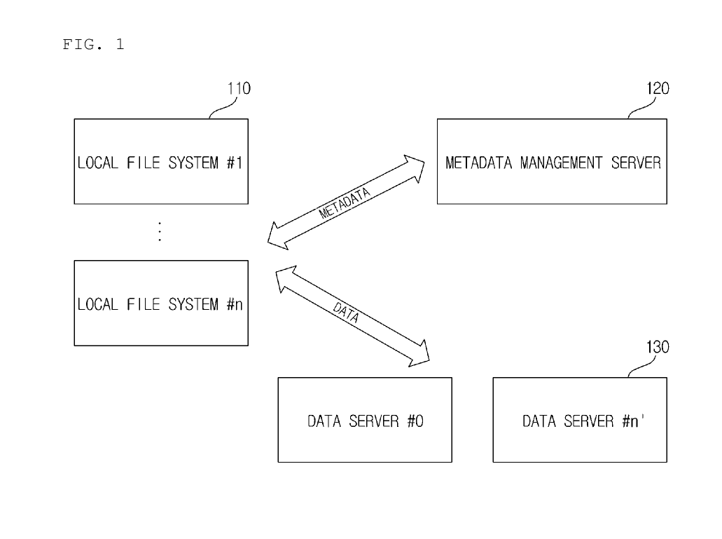

FIG. 2 is an exemplary diagram illustrating pre-reading of a local file system according to the related art.

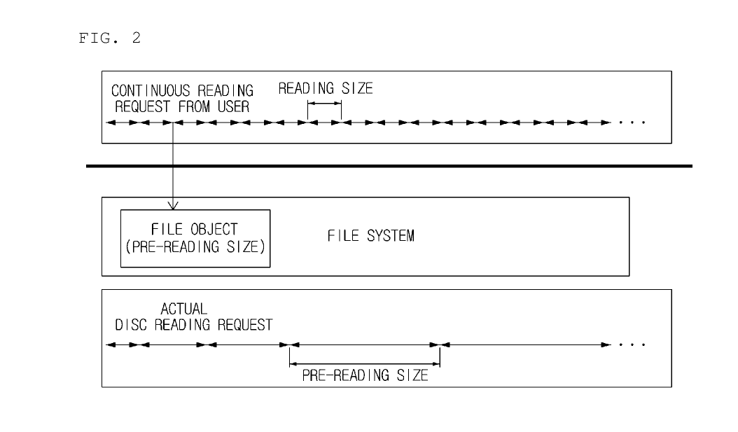

FIG. 3 is an exemplary diagram illustrating a writing process of a local file system according to the related art.

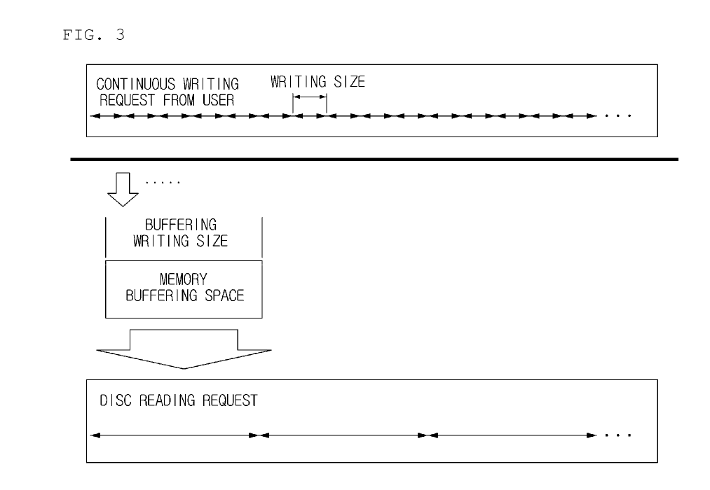

FIG. 4 is an exemplary diagram illustrating the principle of reading or writing, using a context identifier according to an exemplary embodiment of the present invention.

FIG. 5 is an exemplary diagram showing the detailed configuration of a local file system 410 shown in FIG. 4.

FIG. 6 is an exemplary diagram showing the operation principle of the local file system 410 shown in FIG. 4.

FIG. 7 is an exemplary diagram showing the detailed configuration of a data server 420 according to an exemplary embodiment of the present invention.

FIG. 8 is an exemplary diagram showing a context structure according to an exemplary embodiment of the present invention.

FIG. 9 is an exemplary embodiment illustrating the principle of managing the context structure shown in FIG. 8.

FIG. 10 is a first exemplary diagram illustrating the operation principle of the data server 420 according to an exemplary embodiment of the present invention.

FIG. 11 is a second exemplary diagram illustrating the operation principle of the data server 420 according to an exemplary embodiment of the present invention.

FIG. 12 is a third exemplary diagram illustrating the operation principle of the data server 420 according to an exemplary embodiment of the present invention.

FIG. 13 is a fourth exemplary diagram illustrating the operation principle of the data server 420 according to an exemplary embodiment of the present invention.

FIG. 14 is a fifth exemplary diagram illustrating the operation principle of the data server 420 according to an exemplary embodiment of the present invention.

FIG. 15 is a sixth exemplary diagram illustrating the operation principle of the data server 420 according to an exemplary embodiment of the present invention.

FIG. 16 is a seventh exemplary diagram illustrating the operation principle of the data server 420 according to an exemplary embodiment of the present invention.

### DETAILED DESCRIPTION

Various advantages and features of the present invention and methods accomplishing thereof will become apparent from the following description of embodiments with reference to the accompanying drawings. The present invention may, however, be embodied in many different forms without being limited to the embodiments set forth herein. However, the exemplary embodiments of the present invention will be described in detail so that a person with ordinary skilled in the art to which the present invention pertains may easily perform the technical ideas of the present invention.

In the drawings, the exemplary embodiments of the present invention are not limited to a specific form shown and are exaggerated in order to obtain clarity. Further, like reference numerals denote like components throughout the specification.

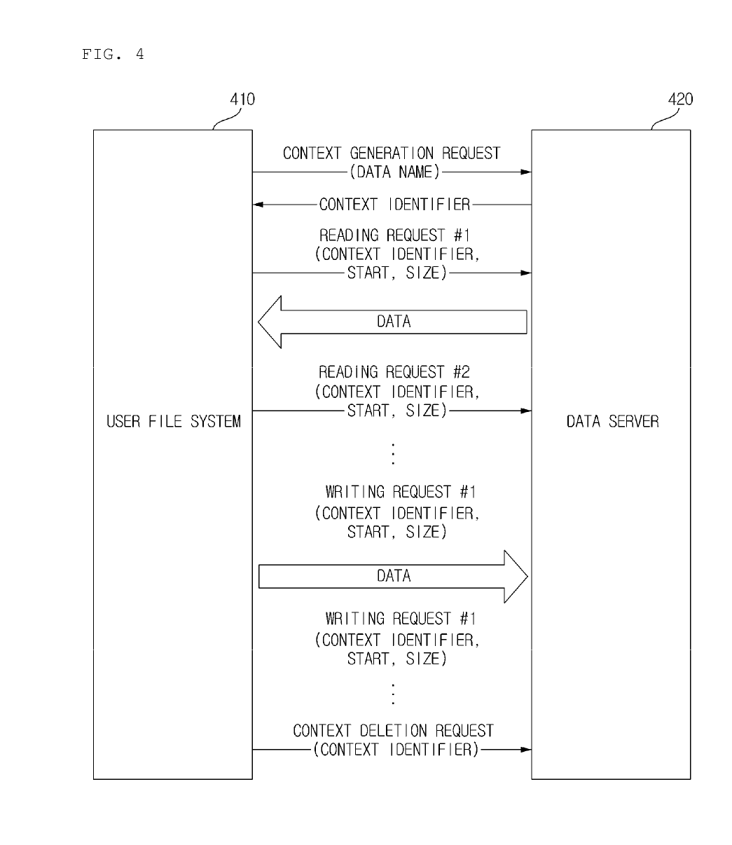

Hereinafter, an apparatus for supporting continuous reading/writing in an asymmetric storage system according to an exemplary embodiment of the present invention and a method thereof will be described with reference to FIGS. 4 to 16. The portions that need to understand the operation and action according to exemplary embodiment of the present invention will be described in detail.

That is, the present invention proposes a method that makes it possible to process continuous reading/writing by providing context identifiers for reading or writing files and requesting reading or writing the files, using the context identifiers.

FIG. 4 is an exemplary diagram illustrating the principle of reading or writing, using a context identifier according to an exemplary embodiment of the present invention.

As shown in FIG. 4, a continuous reading or writing process may be performed through contexts between a local file system 410 and a data server 420 that are connected by a network. In particular, the local file system 410 may request generation of a context first, not directly transmitting a request for reading or writing file data.

A data server 420 correspondingly may generate a context for reading or writing the file data and transmit a context identifier for the generated context to the local file system.

The local file system 410 may request reading or writing the file data, using the context identifier provided from the data server 420.

Thereafter, the local file system 410 may request the data server 420 to delete the context identifier after the process of reading or writing the file data is finished.

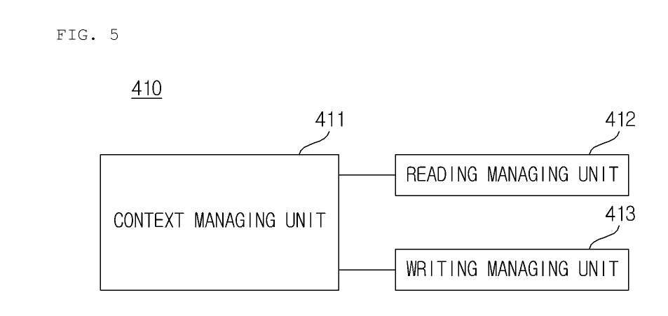

FIG. 5 is an exemplary diagram showing the detailed configuration of a local file system 410 shown in FIG. 4.

As shown in FIG. 5, the local file system 410 according to an exemplary embodiment may include a context managing unit 411, a reading managing unit 412, and a writing managing unit 413.

The context managing unit 411 may request generation of a context for reading or writing file data and receive and store a context identifier for the generated context.

The reading managing unit 412 requests reading of the file data and receives the file data, using the context identifier, and may include the context identifier in the message that requests the reading.

The reading managing unit 413 requests writing of the file data, using the context identifier, and may include the context identifier in the message that requests the writing.

Hereinafter, a process in the local file system 410 that is requested to generate or delete a context from a user is described.

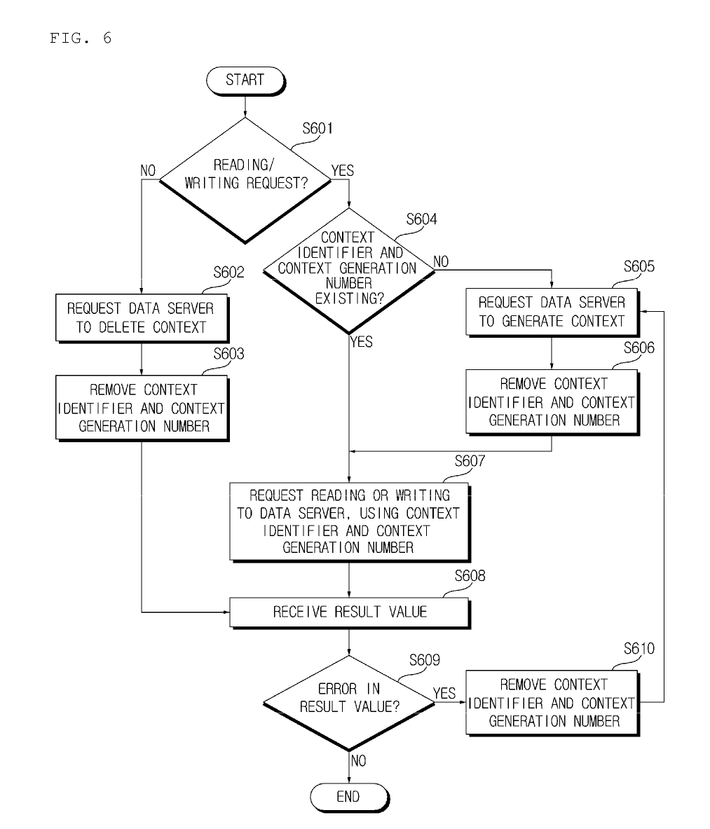

FIG. 6 is an exemplary diagram showing the operation principle of the local file system 410 shown in FIG. 4.

As shown in FIG. 6, the local file system 410 may ascertain whether there is a request for reading or writing a data file from a user (S601). First, the local file system 410 requests the data server to delete the corresponding context, when there is no request for reading or writing a data file from a user (S602).

The local file system 410 deletes the stored context identifier and the file name (S603).

On the contrary, when there is a request for reading or writing a data file from a user, the local file system 410 may ascertain whether a context identifier and a context generation number exist already (S604). This is because the local file system 410 does not directly request the data sever, but requests generation of a context, when receiving a request for reading or writing from a user.

When a context identifier and a context generation number exist already, the local file system 410 may transmit a request for reading or writing the corresponding data file to the data sever, using the context identifier and the context generation number (S607).

On the contrary, when there is not context identifier, the local file system 410 requests the data server to generate a context (S605) and receives and stores a context identifier and a context generation number (S606).

The local file system 410 may transmit a request for reading or writing the corresponding data file to the data sever, using the context identifier and the context generation number (S607).

Accordingly, the local file system 410 is provided with a result value for the reading or writing (S608).

Thereafter, the local file system 410 ascertains whether an error occurs in the provided result value (S609) and processes the request for reading or writing the corresponding data file, when an error does not occur. On the contrary, when an error occurs in the provided result value, the local file system 410 may delete the context identifier and the context generation number (S610) and request again the data server to generate a context (S605).

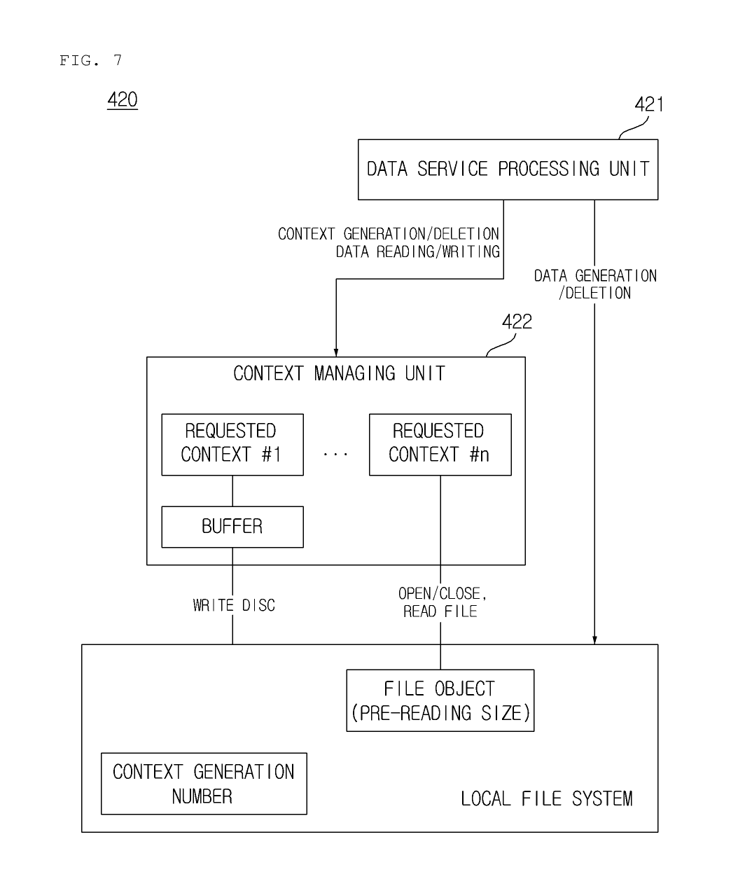

FIG. 7 is an exemplary diagram showing the detailed configuration of a data server 420 according to an exemplary embodiment of the present invention.

As shown in FIG. 7, the data server 420 according to an exemplary embodiment may include a data service processing unit 421 and a context managing unit 422.

The data service processing unit 421 may control generating and deleting of a context and reading and writing of file data in accordance with a request of the local file system. That is, the data service processing unit 421 may request the context managing unit 422 to generate and delete a context and to read and write file data and request the data storing unit 423 to delete the file data, in accordance with a request of the local file system.

The data service processing unit 421 may process generating and deleting of data.

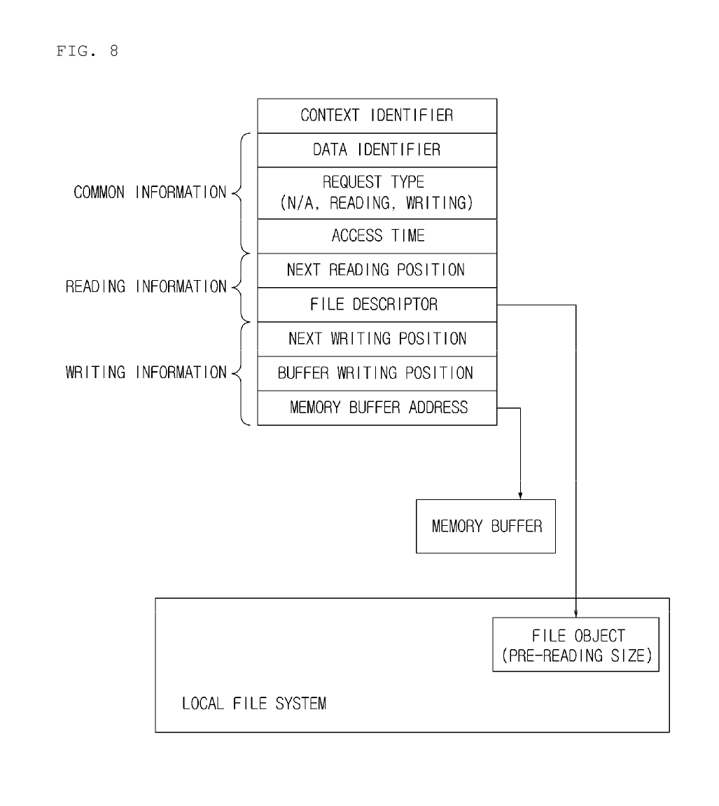

The context managing unit 422 may generate a new context structure in accordance with a request for generating a context, and provide the context identifier included in the generated context structure to the data service processing unit. The context structure generated in this process is described with reference to FIG. 8.

FIG. 8 is an exemplary diagram showing a context structure according to an exemplary embodiment of the present invention.

As shown in FIG. 8, a context structure according to an exemplary embodiment of the present invention may include a context identifier field, a common information field, a reading information field, and a writing information field.

The context identifier field may represent identifiers that are issued to recognize requests of the local file system. The local file system may request a data service, using the context identifier.

The context identifiers are not given to each file data that requests reading or writing, but are differently given to each of users who request reading or writing. For example, the context identifiers is composed of unsigned 64 bits and restarted from 0 when it becomes 264 by increasing one by one from 0 to 264-1.

The common information field is information that is used for both reading and writing processes and may be composed of a data identifier field, a request type field, and an access time filed.

The data identifier field may represent identifiers for recognizing data, the request type filed may represent reading or writing, and the access time field may record the latest access time of the context structure. The access time field may be used to remove the corresponding context structure, when the local file system fails to request deleting of a context or does not use a context for a long period of time after generating the context.

The reading information field is information used for a continuous reading process and may be composed of a next reading position field and a file descriptor field.

The next reading position field may represent the next reading position value for sensing continuous reading. Further, the file descriptor field may represent indicators that are issued when the local file system opens file data. The file descriptor may indicate file objects that perform pre-reading and buffering-writing of the local file system.

The writing information field is information used for a continuous reading process and may be composed of a next reading position field, a memory buffer address field, and a reading position field.

The next writing position field may represent the next writing position value for sensing continuous writing. The memory buffer address field may represent the buffer address of a memory to use and the reading position field may represent a reading position in the buffer.

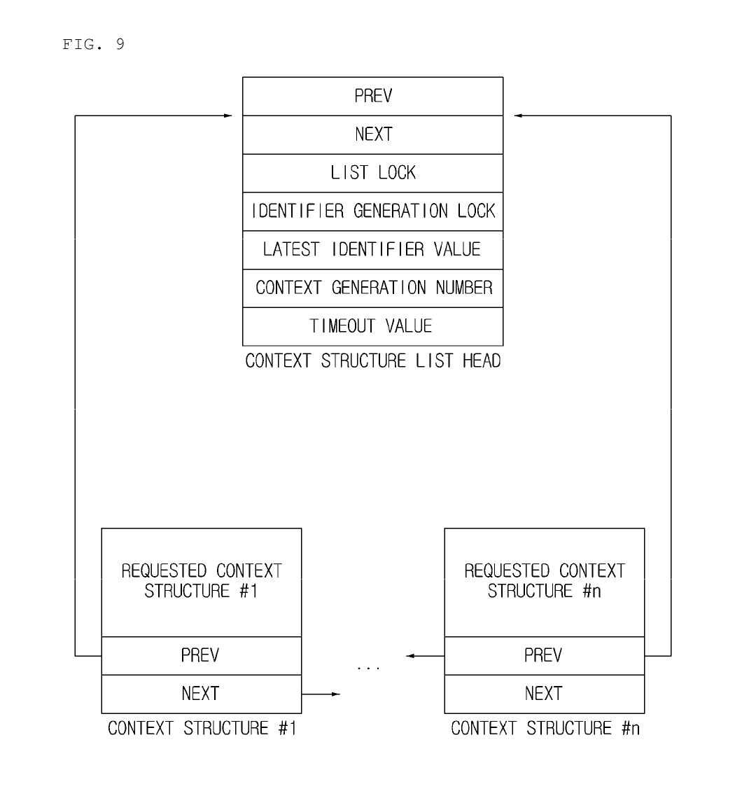

FIG. 9 is an exemplary embodiment illustrating the principle of managing the context structure shown in FIG. 8.

As shown in FIG. 9, the data server according to an exemplary embodiment of the present invention may manage a plurality of context structures, using one context structure list header (hereinafter, referred to as a list header).

The list header makes it possible to search the entire context structure by connecting the start with the end of a list, that is, the entire context structure.

The list header may include a PREV field, a NEXT field, a list lock field, an identifier generation lock field, a latest identifier field, a context generation number, and a timeout field.

The PREV field may represent an indicator for connecting the previous context structure and the NEXT field may represent an indicator for connecting the next context structure.

The list lock field is a field for controlling synchronicity in configuring a list and may search, add, and delete a context structure in the list by the list lock.

The identifier generation lock is a field for uniquely increasing the latest identifier value for generating an identifier and the latest identifier field may represent the latest issued context identifier.

The context generation number may represents a number that increases by one every time a context identifier is generated.

The timeout field may represent a time where a context structure can be maintained as long as possible and may remove the corresponding context structure when not being used for a timeout time.

The context structure constituting a list is composed of the PREV field and the NEXT field, in which the PREV field may represent an indicator for connecting the previous context structure and the NEXT field may represent an indicator for connecting the next context structure.

A process in the data server 420 that receives requests for generating or deleting a context structure list head and a context from the local file system.

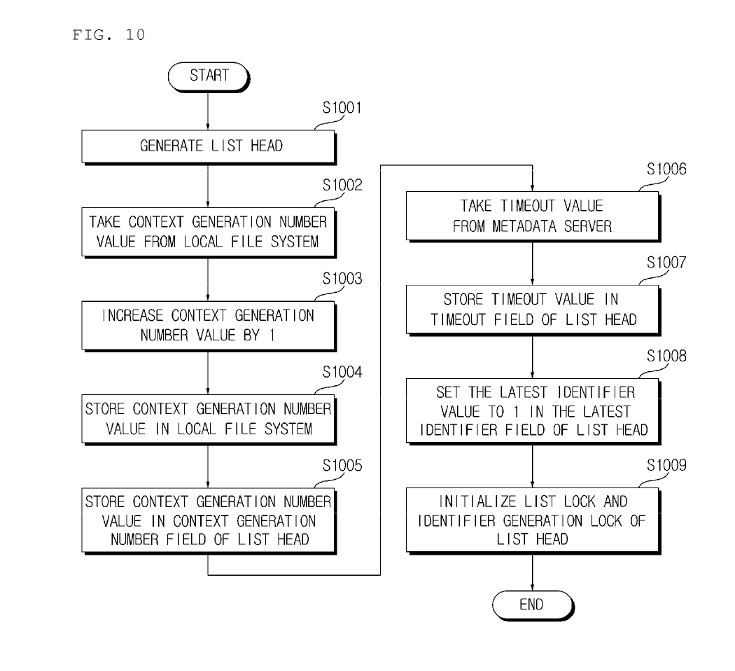

FIG. 10 is a first exemplary diagram illustrating the operation principle of the data server 420 according to an exemplary embodiment of the present invention.

As shown in FIG. 10, in the process of generating a context structure list head, a context structure list head may be generated by driving the data server 420.

Next, the data server 420 may increase a context generation number value by 1, by taking the context generation number value from the local file system. Further, the data server 420 may store the context generation number value in the local file system. Thereafter, the data server 420 may store the context generation number value in the context generation number field of the list head.

Next, data server 420 may take a timeout value from a metadata server and store the timeout value in the timeout field of the list head.

Next, the data server 420 may set the latest identifier value to 1 in the latest identifier field of the list head and initialize the list lock and the identifier generation lock of the list head.

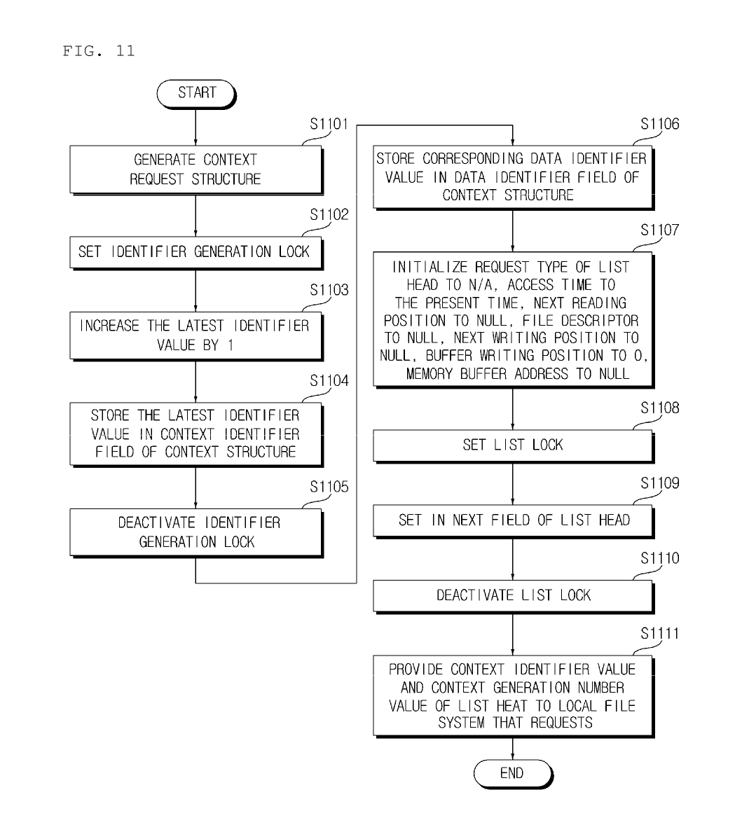

FIG. 11 is a second exemplary diagram illustrating the operation principle of the data server 420 according to an exemplary embodiment of the present invention.

As shown in FIG. 11, in the process of generating a context, the data server 420 may generate a context structure when receiving a request for generating a context from the local file system (S1101).

Next, the data server 420 sets identifier generation lock (S1102). Further, the data server 420 may increase the latest identifier value by 1 (S1103) and may store the latest identifier value in the context identifier field of the context structure (S1104). Thereafter, the data server 420 may release the identifier generation lock (S1105).

Next, the data server 420 may store the corresponding data identifier value in the data identifier field of the context structure (S1106).

The data server 420 may initialize the request type field of the list head to N/A (Not Applicable), the access time filed to the present time, the next reading position to null, the file descriptor to null, the next writing position to null, the buffer writing position to 0, and the memory buffer address to null (S1107).

Next, the data server 420 may set list lock (S1108). Further, the data server 420 may set an indicator for connecting a context structure in the NEXT field of the list head (S1109). Thereafter, the data server 420 may deactivate the list lock (S1110).

Next, the data server 420 may provide the generated context identifier value and the context generation number of the list head in the local file system that requests the generation of the contexts (S1111).

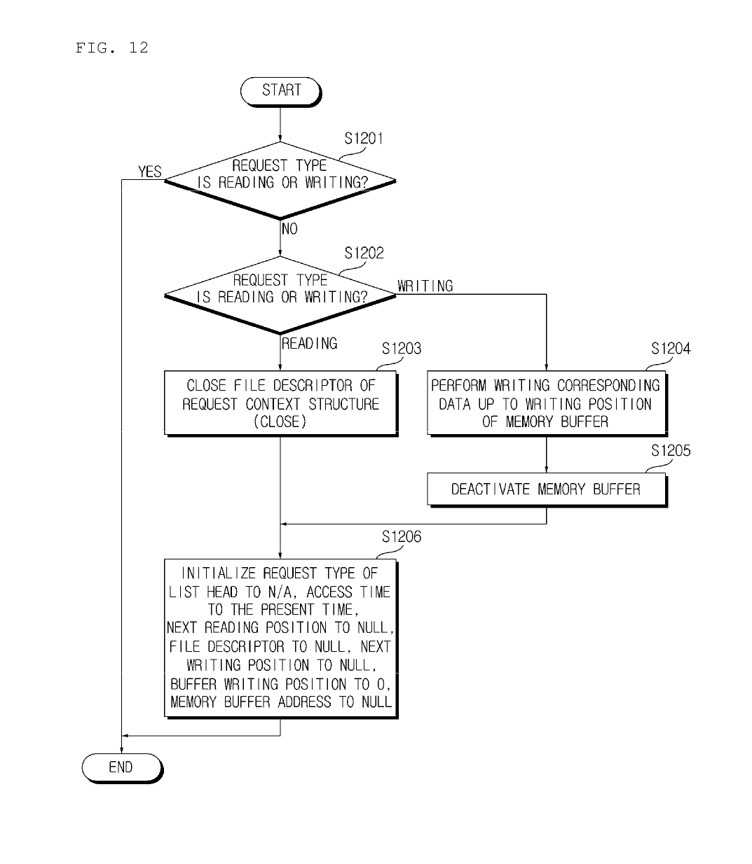

FIG. 12 is a third exemplary diagram illustrating the operation principle of the data server 420 according to an exemplary embodiment of the present invention.

As shown in FIG. 12, not in a continuous reading or continuous writing, the data server 420 may ascertain whether the request type of the generated context structure is N/A (S1201). The data server 420 may finish the corresponding process, when the request type is N/A.

Next, the data server 420 may ascertain whether the request type is reading or writing, when the request type is not N/A (S1202). The data server 420 closes the file descriptor of the context structure, when the request type is reading (S1203). Further, the data server 420 may initialize the request type to N/A, the access time to the present time, the next reading position to null, the file descriptor to null, the next writing position to null, the buffer writing position to 0, and the memory buffer address to null (S1206).

Next, the data server 420 may write the corresponding data up to the buffer writing position of the memory buffer, when the request type is writing. Thereafter, the data server 420 may breaks up the memory buffer (S1205). Next, the data server 420 may initialize the request type to N/A, the access time to the present time, the next reading position to null, the file descriptor to null, the next writing position to null, the buffer writing position to null, and the memory buffer address to null (S1206).

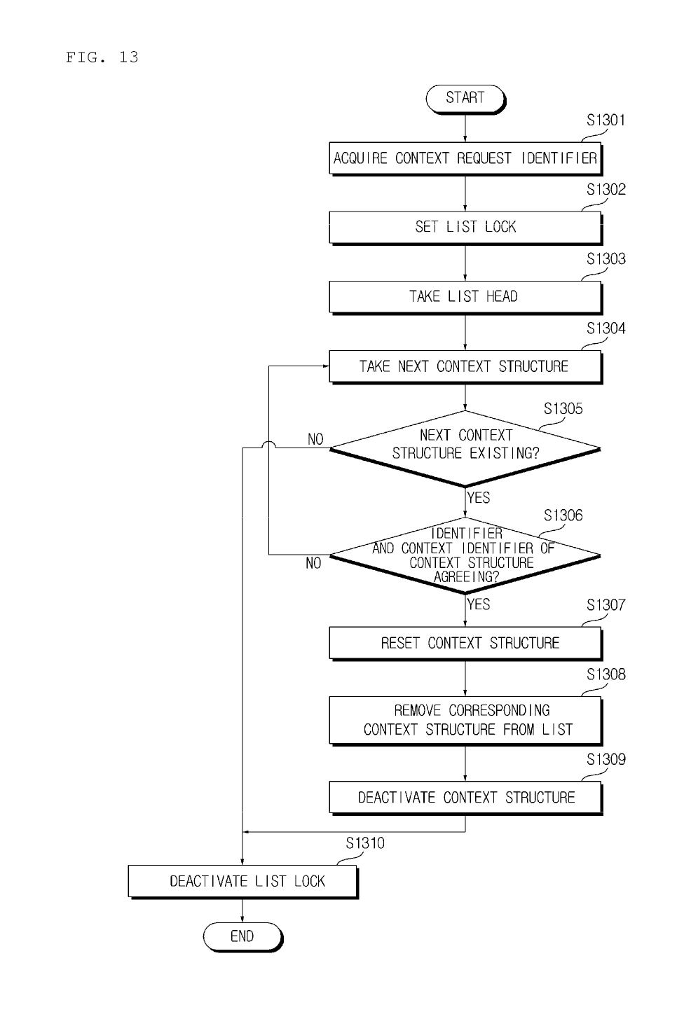

FIG. 13 is a fourth exemplary diagram illustrating the operation principle of the data server 420 according to an exemplary embodiment of the present invention.

As shown in FIG. 13, in the process of deleting a context, the data server 420 may acquire a context identifier when receiving a request for deleting a context from the local file system (S1301).

Next, the data server 420 sets list lock (S1302). The data server 420 correspondingly takes a list head (S1303) and takes the next context structure (S1304). Further, the data server 420 ascertains whether the next context structure exists in the taken context structure (S1305).

Next, the data server 420 ascertains whether the context identifier and the identifier of the next context structure agree with each other, when the next context structure exists (S1306). That is, the data server 420 performs search a context in the list with the identifier until fining a context structure having the corresponding context identifier from the list head.

Next, when the identifiers agree with each other, the data server 420 resets the context structure (S1307) and removes the corresponding context structure from the list (S1308). Thereafter, the data server 420 deactivates the corresponding context structure (S1309) and deactivates the list lock (S1310). On the contrary, when the identifiers do not agree with each other, the data server 420 calls again the next context structure.

The data server 420 deactivates the list lock, when the next context structure do not exist.

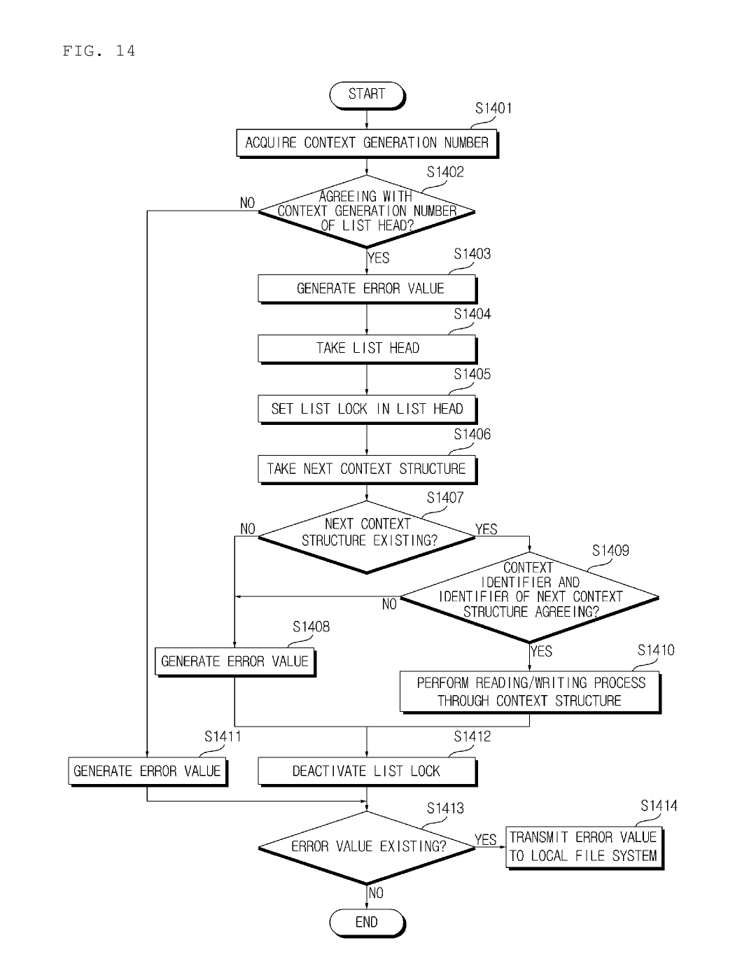

FIG. 14 is a fifth exemplary diagram illustrating the operation principle of the data server 420 according to an exemplary embodiment of the present invention.

As shown in FIG. 14, in the process of reading or writing, the data server 420 may acquire a context generation number when receiving a request for reading or writing from the local file system (S1401).

Next, the data server 420 may ascertain whether the acquired context generation number agrees with the context generation number of the list head (S1402). When the context generation numbers agree with each other, as the result of ascertaining, the data server 420 may acquire a context identifier for the request for reading or writing (S1403). On the contrary, when they do not agree with each other, the data server 420 may generate an error value (S1411).

Next, the data server 420 may take a list heat (S1404) and set list lock of the list head (S1405). Further, the data server 420 takes the next context structure (S1406) and ascertains whether the next context structure exists in the taken context structure (S1407).

Next, the data server 420 ascertains whether the context identifier and the identifier of the next context structure agree with each other, when the next context structure exists (S1409). That is, the data server 420 performs search in the list until fining a context structure having the corresponding context identifier from the list head, using the context identifier.

Next, when the identifiers agree with each other, the data server 420 may perform reading or writing through the context structure (S1410). On the contrary, when the identifiers do not agree with each other, the data server 420 calls again the next context structure.

The data server 420 may generate an error value (S1408) and deactivate the list lock (S1412), when the next context structure does not exist.

Next, the data server 420 ascertains whether an error value exists (S1413), and may transmit the error value to the local file system when an error value exists, as the result of ascertaining (S1414). The data server 420 may finish the corresponding process, when an error value does not exist.

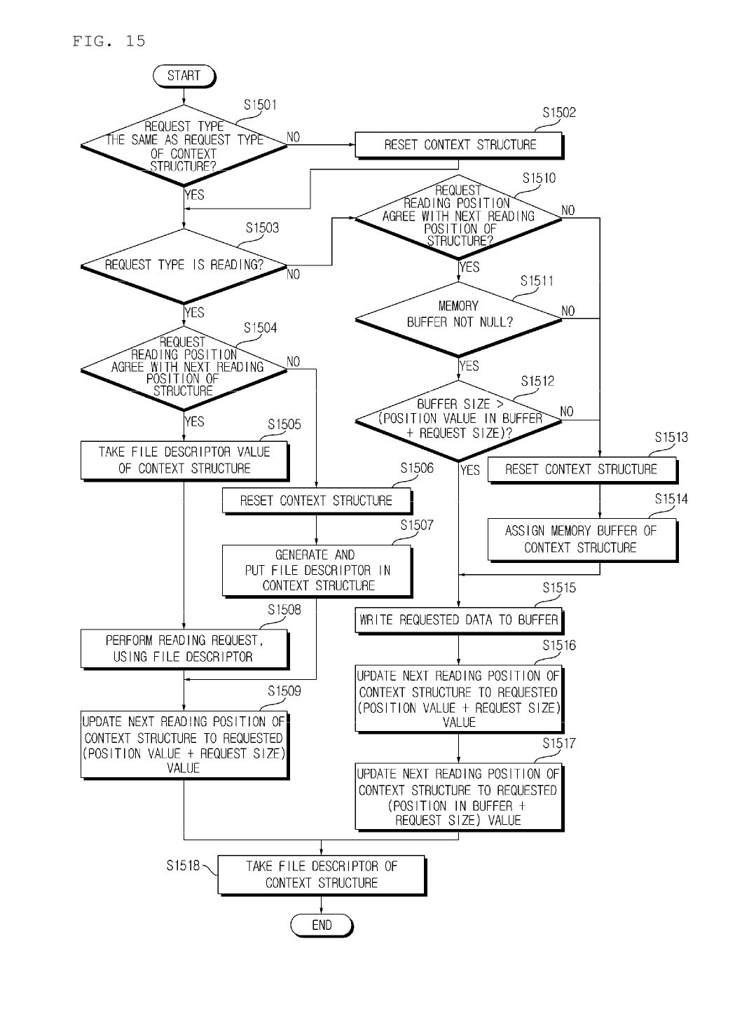

FIG. 15 is a sixth exemplary diagram illustrating the operation principle of the data server 420 according to an exemplary embodiment of the present invention.

As shown in FIG. 15, in a process of reading or writing through a context structure, the data server 420 may ascertain whether a request type agrees with the request type of a context structure (S1501). The data server 420 may reset a context structure when the request types do not agree with each other (S1502).

Next, the data server 420 may ascertain whether the request type is reading or writing (S1503). The data server 420 may ascertain whether the position of the requested reading agrees with the position of the next reading of the context structure, when the request type is a reading request (S1504). When the positions agree with each other, as the result of ascertaining, the data server 420 may take the file descriptor value of the context structure.

On the contrary, when the positions do not agree with each other, the data server 420 may reset the context structure (S1506), generate a file descriptor for the corresponding data in the local file system and put the file descriptor in the context structure (S1507).

Next, the data server 420 may perform a reading request, using the file descriptor value (S1508).

Next, the data server 420 may update the position of the next reading of the context structure to a value obtained by adding the requested position value and the request size (S1509) and update the access time to the present time (S1518).

On the contrary, when the request type is a reading request, the data server 420 may ascertain whether the position of the requested writing agrees with the next reading position of the context structure (S1510). When the positions agree with each other, as the result of ascertaining, the data server 420 may ascertain whether the memory buffer is null or not (S1511). When the memory buffer is not null, the data server 420 may ascertain whether the buffer size is larger than the value obtained by adding the position value in the buffer and the requested size (S1512).

On the contrary, the data server 420 may reset the context structure (S1513) and assign a memory buffer (S1514), when the position of the requested reading does not agree with the next reading position of the context structure, or the memory buffer is null, or the buffer size is smaller than the value obtained by adding the position value in the buffer and the requested size.

Next, the data server 420 writes the requested data on the buffer when the buffer size is larger than the value obtained by the position value in the buffer and the requested size (S1515), and may update the next writing position of the context structure to the value obtained by adding the requested position value and the requested size (S1516).

Next, the data server 420 may update the position in the buffer of the context structure to the value obtained by adding the position value in the buffer and the requested size (S1517) and update the access time to the present time (S1518).

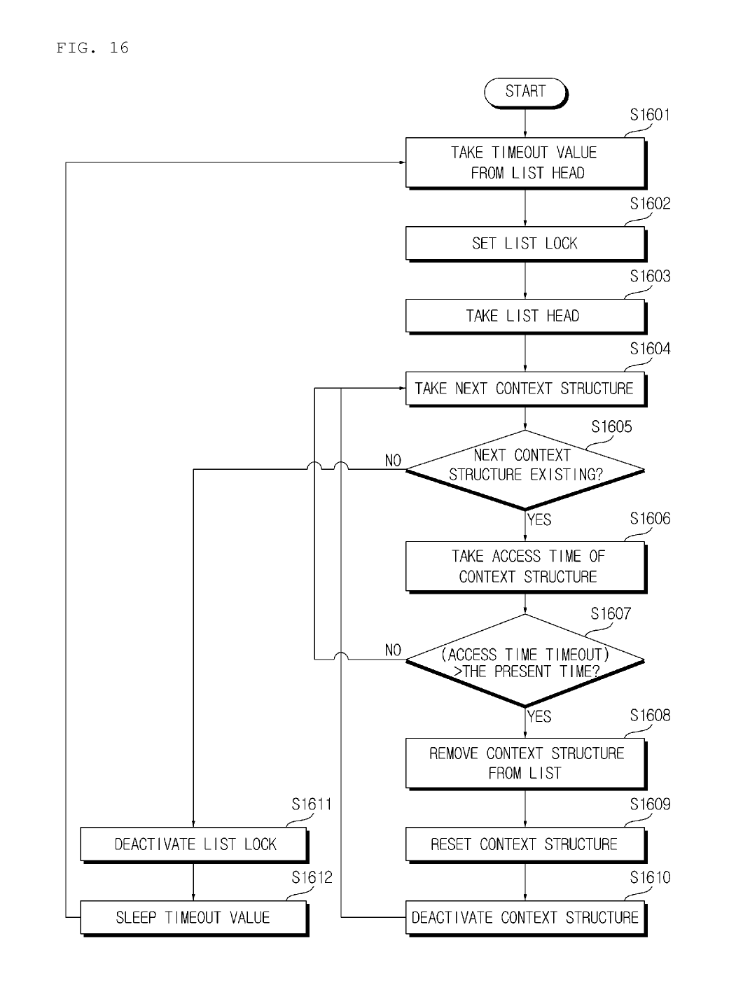

FIG. 16 is a seventh exemplary diagram illustrating the operation principle of the data server 420 according to an exemplary embodiment of the present invention.

As shown in FIG. 16, when collecting context structures, the data server 420 takes the timeout value from the head list (S1601). Further, the data server 420 may set list lock (S1602).

Next, the data server 420 takes a list head (S1603) and takes the next context structure (S1604). Further, the data server 420 ascertains whether the next context structure exists in the called context structure (S1605).

Next, the data server 420 takes the access time value of the context structure when the next context structure exists (S1606), and may ascertain whether the value obtained by adding the access time value to the timeout value is larger than the present time (S1607).

Next, the data serer 420 may remove the context structure from the list (S1608) and reset the context structure (S1609), when the value obtained by adding the access time value to the timeout value is larger than the present time. Further, the data server 420 may deactivate the context structure (S1610).

Thereafter, the data server 420 takes the next context structure (S1604). Further, the data server 420 takes the next context structure even if the value obtained by adding the access time value to the timeout value is smaller than the present time (S1605).

On the contrary, the data server 420 may deactivate the list lock (S1611) and sleep as much as the timeout value (S1612), when the next context structure does not exist. Thereafter, the data server 420 wakes up from the sleep state and performs the collection process function again from the first step.

Therefore, the present invention can efficiently process continuous reading or writing and improve performance of a data service, by providing context identifiers for reading or writing files and requesting reading or writing the files, using the context identifiers. Further, the present invention can reduce waster of a memory by removing context identifies for reading or writing files when the files are not used any more or not frequently used.

The apparatus for supporting read/write in an asymmetric storage system and a method thereof according to the exemplary embodiments of the present invention can be variously changed and modified within a range which is not deviated from the fundamental features of the present invention by those skilled in the art. Therefore, the exemplary embodiments of the present invention described above are used in a generic and descriptive sense only and not for purposes of limitation. The scopes and sprits of the present invention should not be limited to the above-described exemplary embodiments and the following claims as well as all modified equally or equivalently to the claims are intended to fall within the scopes and spirits of the invention.

What is claimed is:

1. An apparatus for supporting continuous read/write, comprising:
a data service processing unit that controls generating and deleting of a context structure, which is assigned for a reading or writing process for each user, and reading and writing of file data, in accordance with a data service request from the users; and
a data context managing unit that generates a context structure in accordance with a context generation request and provides a context identifier and a context generation number included in the generated context structure to the data service processing unit,
wherein the context managing unit determines that the request is continuous reading or continuous writing when the reading or writing request position of a local file system agrees with the next reading position or the next writing position of the context structure, through the context identifier and the context generation number, and then performs a continuous reading request or a continuous writing request, using a file descriptor of the context structure.

2. The apparatus of claim 1, wherein the context managing unit determines that a request is continuous reading, when the context generation number of the reading request and the context generation number of the context structure list head agree with each other, the context identifier of the reading request and the context identifier of the context structure agree with each other, and the reading request position and the next reading position of the context structure agree with each other.

3. The apparatus of claim 1, wherein the context managing unit determines that a request is continuous writing, when the context generation number of the writing request and the context generation number of the context structure list head agree with each other, the context identifier of the writing request and the context identifier of the context structure agree with each other, and the writing request position and the next writing position of the context structure agree with each other.

4. The apparatus of claim 1, wherein the context structure includes at least one of a context identifier field that represents information given to each of users who requests reading or writing, a common information field that represents information that is used in reading or writing, a reading information field that represents information that is used in a continuous reading process, and a writing information field that represents information that is used in a continuous writing process.

5. The apparatus of claim 4, wherein the read information field includes a next reading position field that represents the next reading position value for determining whether the reading request is continuous reading.

6. The apparatus of claim 4, wherein the read information field includes a next writing position field that represents the next writing position value for determining whether the writing request is continuous writing.

7. The apparatus of claim 1, wherein the data service processing unit performs a process of generating or deleting a data file.

8. The apparatus of claim 1, wherein the context managing unit manages a context structure list including a plurality of context structures, using a context structure list head.

9. The apparatus of claim 8, wherein the context structure list head includes a PREV field that represents an indicator for connecting the previous context structure, a NEXT field that represents an indicator for connecting the next context structure, a list lock filed that controls a list configuration, an identifier generation lock field that increases the value of a context identifier to be generated, a latest identifier field that represents the value of the latest issued context identifier, a context generation number that represents a number corresponding to the context identifier value, and a timeout field that represents a time where a context structure can be maintained as long as possible.

10. The apparatus of claim 1, wherein the context managing unit generates the context identifier in accordance with the context generation request of a local file system and generate the context generation number corresponding to the context identifier, and the context generation number is generated by increasing one by one the context generation numbers stored in the local file system.

11. An asymmetric storage system, comprising:
a local file system that requests for generating a context structure for reading or writing in accordance with a data service request from a user; and
a data server that generates a context structure in accordance with a context generation request and provides a context identifier and a context generation number included in the context structure to the local file system,
wherein the data server determines that the request is continuous reading, when the reading request position of the local file system agrees with the next reading position of the context structure, through the context identifier and the context generation number, and then performs a continuous reading request, using a file descriptor of the context structure.

12. A method for supporting continuous read/write, comprising:
generating a context structure including a context identifier that is assigned for each of users who request reading, when receiving the reading requests from the users;
determining whether the reading request position agrees with the next reading position of the context structure; and
determining that the request is continuous reading, when the reading request position of the local file system agrees with the next reading position of the context structure, as the result of determining, and then performing a continuous reading request, using a file descriptor of the context structure.

13. The method of claim 12, wherein the generating a context structure includes:
generating a context structure list head for managing a list including a plurality of context structures in accordance with a context generation request from a local file system receiving a reading request from a user;
generating a context generation number included in the context structure list head;
generating the context structure assigned to each of users who requests reading;
generating the context identifier included in the context structure; and
providing the context generation number and the context identifier to the local file system that requests reading.

14. The method of claim 13, wherein the determining whether the reading request position agrees with the next reading position includes:
determining whether the identifier generation number of the reading request and the context generation number of the context list head agree with each other in accordance with a reading request from a local file system through the context generation number and the context identifier;
determining whether the context identifier of the reading request and the context identifier of the context structure agree with each other when the context generation numbers agree with each other; and
determining whether the position of the reading request agrees with the next reading position of the context structure when the context identifiers agree with each other.

15. The method of claim 12, further comprising:
updating the next reading position of the context structure to a value obtained by adding the position value of the reading request and the size value of the reading request, after performing the continuous reading request.

16. A method for supporting continuous read/write, comprising:
generating a context structure including a context identifier that is assigned for each of users who request writing, when receiving the writing requests from the users;
determining whether the writing request position agrees with the next writing position of the context structure; and
determining that the request is continuous writing, when the writing request position of the local file system agrees with the next writing position of the context structure, as the result of determining, and then performing a continuous writing request, using a file descriptor of the context structure.

17. The method of claim 16, further comprising:
updating the next writing position of the context structure to a value obtained by adding the position value of the writing request and the size value of the writing request, after performing the continuous writing request; and
updating the buffer writing position of the context structure to a value obtained by adding the buffer writing position value of the writing request and the size value of the writing request.
